(19) United States
(12) Patent Application Publication
(10) Pub. No.: US 2015/0074008 A1
(43) Pub. Date: Mar. 12, 2015

(54) SECURE IDENTIFICATION SYSTEM AND METHOD

(71) Applicant: SYNABEE, INC., Wellington, FL (US)

(72) Inventors: Noel J. Guillama, Wellington, FL (US); Chester Heath, Boca Raton, FL (US)

(73) Assignee: SYNABEE, INC, Wellington, FL (US)

(21) Appl. No.: 14/395,196

(22) PCT Filed: Apr. 22, 2013
(86) PCT No.: PCT/US13/37565

§ 371 Date: Oct. 17, 2014

Related U.S. Application Data
(60) Provisional application No. 61/635,910, filed on Apr. 20, 2012.

(51) Int. Cl. G06Q 50/26; G06Q 40/00

(52) U.S. Cl. CPC G06Q 50/265; G06Q 40/00
USPC 705/325

(57) ABSTRACT

A computer based system is provided which utilizes a machine readable code presented by one intelligent (handheld) device and read by another. The existing credit authorization means used by banking, or other authorization means, validated the operator of the handheld, which may further be associated to the owner with an RFID, Bluetooth, biometric, or similar device held on the person of the operator or perhaps embedded on the individual. Transactions between secure servers allow validation of identity and monetary transfers.

### CROSS-REFERENCE TO RELATED APPLICATIONS

This application claims priority to and the benefit of U.S. Provisional Patent Application No. 61/635,910, entitled “SECURE IDENTIFICATION SYSTEM AND METHOD” and filed Apr. 20, 2012, the contents of which are herein incorporated by reference in their entirety.

### FIELD OF THE INVENTION

The present invention is related to identification of individuals to one another, within a group, authorization of individuals, vehicles, or groups to secure areas, control of secure monetary and credit transactions within a known group, social networking and identification of friend versus foe in conflict situations.

### BACKGROUND

The confirmation of the identity of objects, persons, and entities is well-known problem. History and fiction abounds with tales of letters, tokens, signets and passwords used to confirm identity and the consequences which have followed from their loss or forgery.

In modern times the most prevalent solution to this problem is an identification card which serves to establish identity, as well as usually some characteristic, status, or attribute of the bearer. For example, with respect to persons, the most common identification is a driver's license. Typically, such identification cards will include a picture of the nominal bearer as well as relevant information in text form. While identification cards, such as driver's licenses, and the like have generally been proven useful under most circumstances, they are nevertheless still subject to forgery or tampering, even in the face of modern requirements, such as the REAL ID Act of 2005.

Further, in the case of certain transactions, misuse of certain types of identification cards is commonplace. For example, in the case of medical insurance cards, the card will typically list the name of the insured, but not much other identification information. Accordingly, if a valid medical insurance card is presented by a person to a provider, the card may be accepted without question by the provider. Even if secondary identification is requested by the provider, as long as the names match, the card may be accepted. Thus, multiple persons with secondary identification listing the same name are able to utilize the same medical insurance card. Further, if the secondary identification is forged to match the name on the medical insurance card, the result is the same. A similar problem exists with other type of cards, including credit cards.

A solution to verifying an identity of individuals is to utilized techniques developed to recognize fingerprints, voice patterns, retinal patterns, or other characteristics of individuals. Such systems are highly successful in uniquely identifying individuals known to the system, but are subject to the disadvantages of requiring highly sophisticated, expensive sensors, which are typically not mobile, and which must be connected to a database which identifies selected individuals in terms of physical characteristics such as fingerprints.

However, for more basic transactions, these sophisticated systems are generally too costly and cumbersome. Accordingly, there is a need for providing a secure method for identification that does not rely on elaborate or extensive measures.

### SUMMARY

Embodiments of the invention concern a computer based system utilizing a machine readable code presented by one intelligent (handheld) device and read by another. The existing credit authorization means used by banking, or other authorization means , validated the operator of the handheld, which may further be associated to the owner with an RFID, Bluetooth, biometric, or similar device held on the person of the operator or perhaps embedded on the individual. Transactions between secure servers allow validation of identity and monetary transfers. Applications in retail sales could allow retail establishments to authorize and effect monetary transaction in close proximity, at a distance, or both. As an aide to the reduction of fraud and identity theft. Medical services can be provided by a known credentialed provider to a known patient, who are established to be present at the same place in time at a facility where such services are provided such that additional fees cannot be charged unrelated to the meeting of patient and provider and such that a patients identity is assured for proper coherence of medical records. Further as a means to establish identity, battlefield friend versus foe identification could be automated, as well as homeland security identification at borders, and emergency location of individuals in disasters. Although not limited to individuals in close proximity, the concept is specifically useful for personal identification of unknown parties to each other in direct personal contact—and authentic validation of such meetings to third parties.

In a first embodiment, there is provided a method of secure authentication. The method includes providing, from a first server to a first client associated with a first party to a transaction, an authorization to generate machine readable code representing one or more items available for transfer and identity information of a first party. The method also includes receiving, at a second server from a second client associated with a second party to a transaction, a request based on an interpretation of the machine readable pattern, the request including an identity associated with the machine readable code and a request for transfer of at least a portion of the items specified in the machine readable code. The method further includes forwarding, from the second server to the first server, a communication for the first server to process the request. The method also includes, responsive to completion of the processing of the request, transferring the items between the first server and the second server and configuring the first server to notify the first client of the transfer of the items and configuring the second server to notify the second client of the transferring of the items.

In the method, the items include financial information or additional identification information.

The method can also include, responsive to a failure to complete the processing of the request, configuring the first server to notify the first client of the failure, and configuring the second server to notify the second client of the failure.

The method can also include providing a first supervisory server associated with the first server, providing a second supervisory server associated with the second server, and configuring the first supervisory server and the second supervisory server to complete a handshake operation prior to the processing of the request.

The method can also include applying an encryption process to transmit and receive messages between the first server and the first device and between the second server and the second device, wherein an encryption key for the encryption process can be selected to be valid for only a limited time.

In a second embodiment, there is provided a client device for secure authentication processes. The device includes a processor and a computer-readable medium having stored thereon a plurality of instructions for causing the processor to perform a method. The method can include receiving, from a first server, an authorization to generate machine readable code representing one or more items available for transfer and identity information of a first party to a transaction. The method can also include providing, to a other client device associated with a second party to a transaction, the machine readable pattern and , subsequent to the providing, receiving, from the first server, an indication of the completion of the processing of a request from the other client device to the second server to authenticate the transaction via an authentication process between the first server and a second server and that items were are transferred between the first server and the second server.

In the client device, subsequent to the providing, the method can include receiving, from the first server, an indication of a failure to complete of the processing of a request from the other client device to the second server to authenticate the transaction via an authentication process between the first server and a second server.

In the client device, the items can include financial information or additional identification information. Further, the plurality of instructions can include instructions for causing the processor to perform the receiving of the authorization and the receiving of the indication using encrypted communications via a secure terminal, where an encryption key for the encrypted communications is valid for only a limited time.

In a third embodiment of the invention, there is provided another client device for secure authentication processes. The client device can include a processor and a computer-readable medium, having stored thereon a plurality of instructions for causing the processor to perform a method. The method can include receiving, from a other client device associated with a first party to a transaction, a machine readable pattern representing one or more items available for transfer and identity information of the first party. The method can also include transmitting a message to a second server associated with a second party to the transaction, where the message is based on an interpretation of the machine readable pattern, and the message including the identity associated with the machine readable code and a request for transfer of at least a portion of the items specified in the machine readable code from a first server associated with the first party to the second server. The method can further include, subsequent to the transmitting, receiving, from the second server, an indication of a completion of the processing of the identity and the request via an authentication process between the first server and a second server and that items were are transferred between the first server and the second server.

In the client device, the method can further include, subsequent to the transmitting, receiving, from the second server, an indication of a failure to complete of the processing of the identity and the request via the authentication process.

In the client device, the items can include financial information or additional identification information. Further, the plurality of instructions can include instructions for causing the processor to perform the transmitting and the receiving of the indication using encrypted communications via a secure terminal, where an encryption key for the encrypted communications is valid for only a limited time.

### BRIEF DESCRIPTION OF THE DRAWINGS

FIG. 1 is a block diagram of a an exemplary transaction according to a first embodiment of the invention;

FIG. 2 is a block diagram of a an exemplary transaction according to a second embodiment of the invention;

FIG. 3 is a block diagram of a an exemplary transaction according to a third embodiment of the invention; and

FIG. 4 is a block diagram of detailing the secure terminal in FIG. 3; and

FIG. 5 is a schematic illustrating the use of augmented reality features in accordance with an embodiment of the invention.

FIG. 6. Is a block diagram of the mutually independent secure transaction acknowledgement” or “MISTA” embodiment; and

FIG. 7 shows an exemplary configuration for computing device capable of carrying out one or more aspects of the various embodiments.

### DETAILED DESCRIPTION

The present invention is described with reference to the attached figures, wherein like reference numerals are used throughout the figures to designate similar or equivalent elements. The figures are not drawn to scale and they are provided merely to illustrate the instant invention. Several aspects of the invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details or with other methods. In other instances, well-known structures or operations are not shown in detail to avoid obscuring the invention. The present invention is not limited by the illustrated ordering of acts or events, as some acts may occur in different orders and/or concurrently with other acts or events. Furthermore, not all illustrated acts or events are required to implement a methodology in accordance with the present invention.

In view of the difficulties associated with identification of individuals, objects, and entities, the various embodiments are directed to new systems and methods for providing secure identification between parties associated with a transaction. In the various embodiments, parties to a transaction can securely identify each other via the exchange of secure messages designed to uniquely identify each party to the other party.

As is apparent from the discussion above and below the most common application of identification cards is to identify persons. However, the problem of identification also extends to a very broad class of objects or other entities. In the case of objects, it may be desirable to be able to definitely establish that a particular item has been processed or to obtain true information regarding the object. For example, in the case of objects being imported into the country, it may be desirable to establish whether or not an object has truly been inspected, passed through customs, or was produced by the company identified in any associated paperwork. Further, it may be desirable to have secure evidence of the provenance of an art work, the pedigree of an animal being purchased, or that a person, animal, or plant is free from disease. Such applications, and others which will be apparent to those skilled in the art are within the contemplation of the subject invention

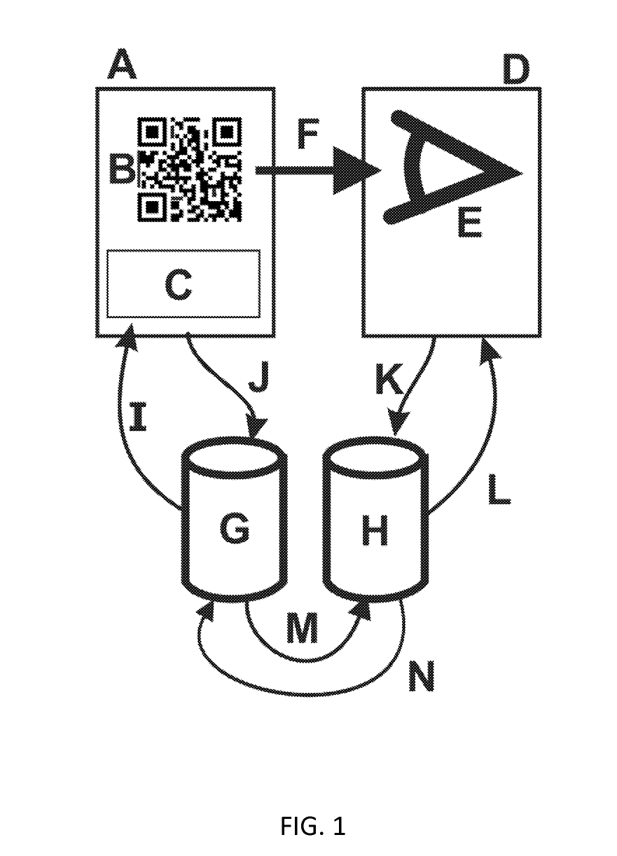

Referring now to FIG. 1, there is shown a block diagram of an exemplary transaction according to a first embodiment of the invention. The transaction of FIG. 1 begins at a computing device of a first party, device A. In the various embodiments, device A can be any type of computing device. In some embodiments, device A can be a handheld computing device, such a smartphone, tablet, or other network-connected portable computing device. Handheld intelligent device A produces a machine readable pattern B based on credits held in whole or in part in C. Note that B can be assembled from interpretation of credits or other information accumulated from one or more transfers I from server G as requested by J.

In operation, the device A would provide a request J to perform the transfer I of credits, or other information, from server G based on input of an operator associated with the credits or information at server G. Thereafter, the credits are allocated from an account in server G to C or the information is transferred from server G to C. For security purposes, the request J and the transfer I can be encrypted. These communications can also contain identity authorization information indicating that device A is an authorized proxy of its operator. Thus, identity is established.

In the embodiment shown in FIG. 1, upon initiating a transaction, the machine readable code B is generated at device A and made available or transferred F to a computing device of a second party to the transaction, device D. For example, as shown in FIG. 1, the machine readable medium B is provided in the form of a barcode and is read by a camera E in at device D to transfer the machine readable code to device D. The machine readable code can contain the identity authorization information and address of a second server H. The address could be fixed, or it could be simply entered or stored as a variable in E. The net result is that D emits or transmits a status K to server H that the credits or information represented by the read operation F have been successfully or unsuccessfully received at E.

As a result a successful transfer F, a request N, including the identity information of the operator of device B, for transfer M of electronic money or other information to server H is provided to Server G from Server H. The transfer M can then occur. Thereafter, the device A is alerted that the successful transfer of M has occurred by transfer I. For example, device A can show in C the transfer I by removing credits or information C. Contemporaneously, transfer L indicates to device B that the electronic money or other information has been received. As a result, both parties receive independent confirmation of the transfer of electronic money or information between servers G and H.

Alternately server G could be alerted by N that the operation F was not successfully received and the transfer M did not occur. This can also include a request of a retry of the transaction. By path I, the operator of A would be alerted to retry the operation. If, after some number of retries the transfer does not occur, the operation would be aborted and both devices A and B alerted accordingly.

The protocol could be simplex, where A communicates solely to B, or reversed such that B communicates solely to A, or duplex with one or more concurrent transactions.

The implementation of the protocols for transfers or communications I and J, storing of credits or information at C, creation of the machine readable code B could be controlled by an application program (not shown) stored in device A. Similarly, the read operation F by camera E and the protocols L and K could be implemented by another application program (not shown) stored in device B.

In the case of electronic transfer of money, the mechanism to perform this proxy payment of electronic funds could be implemented with the server complex G and H assumed by an established electronic bank. The party information for users at both devices A and B might be held in each operators' wallet, for example as an RFID or Bluetooth transfer. That is, the identity of device A and its operator is known to device B and vice-versa. However, this simplified protocol assumes that there are no dishonest people in the world.

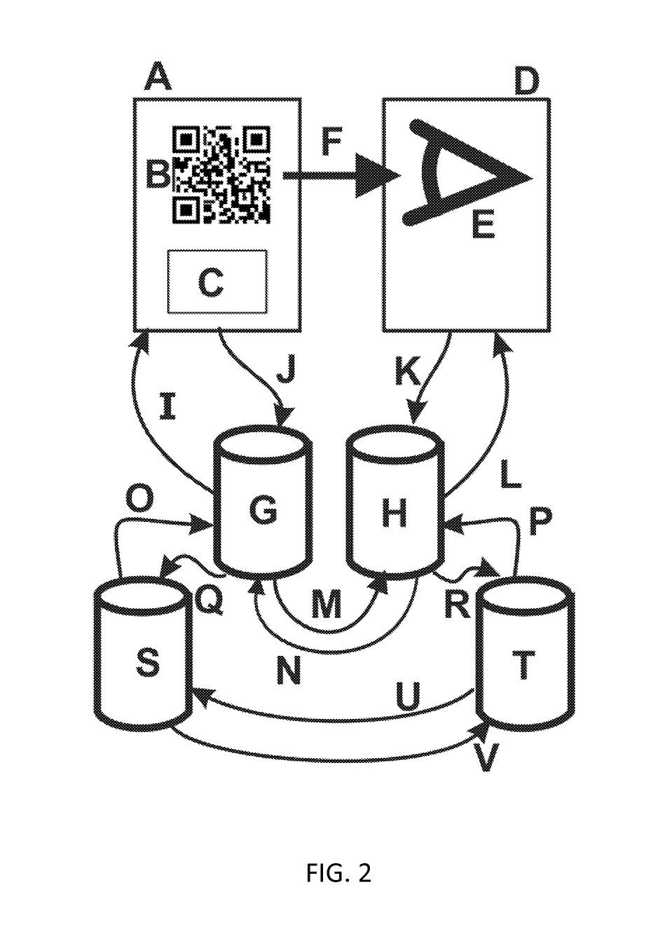

Referring now to FIG. 2, there is shown a block diagram of an exemplary transaction according to a second embodiment of the invention. FIG. 2 includes elements A, B, C, D, E, F, G, H, I, J, K, L, M , and N, similar to the configuration of FIG. 1. Accordingly, the description of these elements in FIG. 1 is sufficient for describing these elements in FIG. 2. In this configuration the programs in devices A and B may also store the location and time of each transfer and pass this (encrypted) information to servers G and H and thus to each party as well.

In the embodiment of FIG. 2, a supervisory set of servers S and T could enable transfers I, J, K, L, M, and N to occur through handshakes, messages, or communications O, Q, P, R, U, and V. Thus this can allow further identifying of participants, typically as members of a group, and storing the location and time information as well. As a result, this adds a second layer of authentication to further ensure the validity of the exchange. For example, the handshakes through servers S and T can be utilized to further authenticate servers G and H to each other before the transfer M is completed.

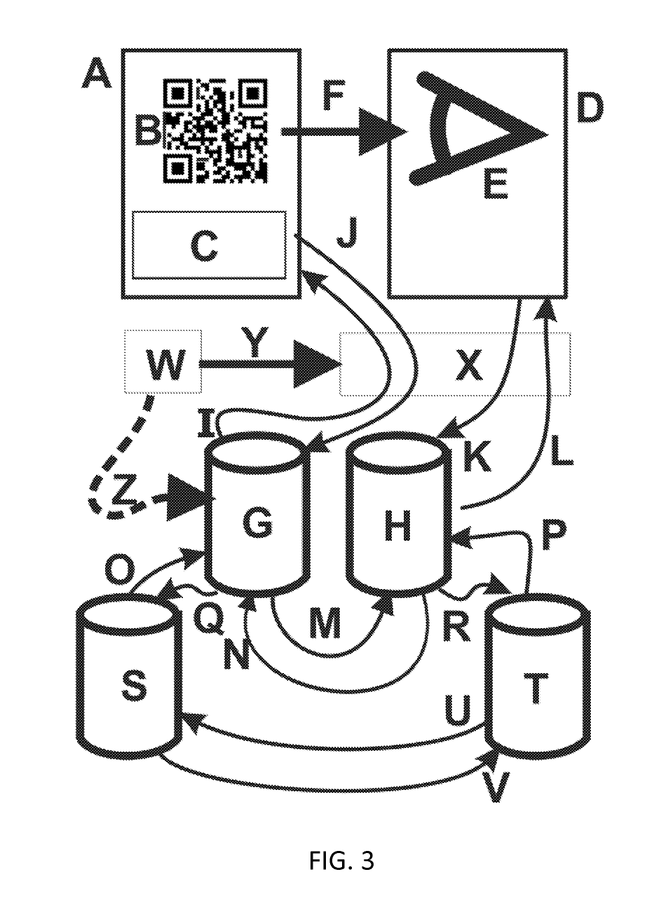

It is understood that there may be attempts to counterfeit machine readable codes and alteration of programs to create and read such codes such that further control and authentication of transfers is required. This is illustrated below with respect to FIG. 3.

In FIG. 3, there is shown is a block diagram of an exemplary transaction according to a third embodiment of the invention. FIG. 3 includes elements A, B, C, D, E, F, G, H, I, J, K, L, M, and N, similar to the configuration of FIG. 1. Accordingly, the description of these elements in FIG. 1 is sufficient for describing these elements in FIG. 3. Further, FIG. 3 also includes elements O, P, Q, R, S, T, U, and V, similar to the configuration of FIG. 2. Accordingly, the description of these elements in FIG. 2 is sufficient for describing these elements in FIG. 3.

FIG. 3 shows that there is a secure terminal W that interrupts or intercepts transfers I, J, K, and L. The secure terminal W can provide a gating mechanism by creating an encryption key for the machine readable code, to produce a unique machine readable pattern that is similarly read as above and authenticated by servers G and H prior to any transfer. Further the encryption key can be configured to be valid only for a short period of time, nominally a minute during which the operation F must be completed along with transfers I, J, K, and L before electronic money or other information is transferred.

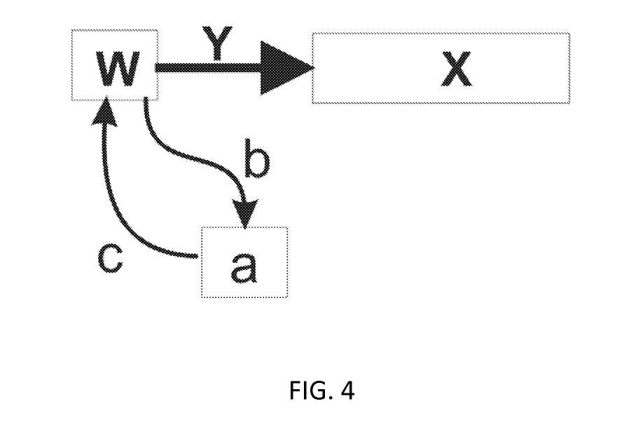

For example, referring now to the secure terminal W in FIG. 4, W may halt Y transfers I, J, K, L via an algorithm {a} that adds {b} and decodes {c} an encryption code for any or all of the transfers through X. A same type of gating mechanism may be implemented for communications O, Q, P, R as an alternate or additional means of security.

Although FIGS. 1-3 are show as being implemented using barcode or other optical machine readable medium, the various embodiments are not limited in this regard. That is, the transfer F can also be implemented via a beacon or broadcasting means, perhaps the bright visible, or clandestine non-visible, LED typical of such cameras that is often used for photo illumination. For example, the machine readable code might then be a series of flashes of light that would be detected by camera E. This would allow connection at longer distances, potentially between moving objects. Alternatively, the beacon can be a radio frequency broadcast. The data stream could of course be encrypted such that it is only meaningful at the source and interpreted by authorized receivers. Because the transfer uses the identities of the operators of device A and B, it can also be used for person to person identification, or using the above longer range example between persons within groups or vehicles.

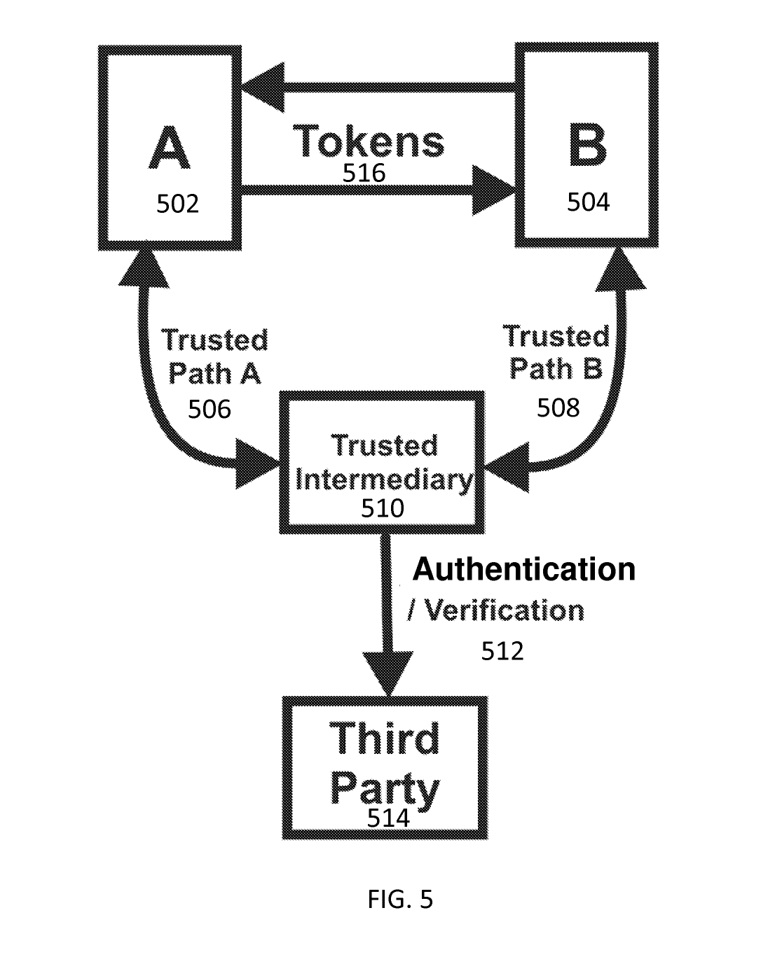

This concept differs from traditional authorization concepts as noted below. Referring to now to FIG. 5, the authorization concepts described herein define a mutually independent secure transaction acknowledgement (MISTA), where each party can establish (through their own trusted communication paths to a trusted intermediary) the identity of the partner in a transaction, the time, the location or position, and provide on the spot authenticity acknowledgement to each party. More important, this methodology allows a party to prove these components to a third party.

This methodology is unique and distinct beyond the traditional credit card transactions as it is mutually secure and verifiable to both parties. These attributes are not seen as components of traditional authorization schemes. For example, consider the scenario when a patient for device A 502 meets with a medical provider associated with device B 504 and each party needs to fully identify the other party though their own trusted paths 506 and 508 respectively to a trusted intermediary 510. As described above, the parties exchange visual or digital MISTA “tokens” of trust per the defined means (i.e., the machine readable code is transferred between devices, as described above with respect to FIG. 1). Geo-location information (e.g., via GPS, network location , etc.) and time stamps can then be used to place both parties at the same place and time, thus verifying the individuals involved in the transaction Such information can also be demonstrated to a third party 514 such as CMS (Medicare payer) to perform authentication and verification processes 512.

In the various embodiments, the trusted intermediary 510 can be a single system, such as that of a banking system or insurance carrier. However, the trusted intermediary 510 can be defined via a server complex. For example, referring back to FIG. 1, the trusted intermediary can be a pair of servers associated with each of the devices 502 and 504.

In some embodiments, biometrics could be used to further authenticate the individuals to the common trusted intermediary 510. For example: the trusted intermediary 510 can store a recorded database of previously spoken words, letters, and phrases for a given individual. To identify the individual as authentic, they must quickly repeat a random arrangement of the recorded terms. For example: the individual must repeat “lamb a red golf” in a few seconds following a prompt using their normal voice. Such quick response is easy for a human and currently very difficult for machine intelligence.

In most credit transactions, a medical provider, a merchant, or the party to whom monies or information is to be provided is typically assumed to be a trusted party and the patient or customer is typically the suspect party when fraud is being committed. However, in some cases, the merchant, medical provider, etc. may be the perpetrator of fraud. Therefore by including authentication of both sides to a transaction, a third party (e.g., a bank or insurance carrier) can perform verification of authenticity in order to assure that both parties are authentic and that the transaction is occurring at the same time and place. For example, in the case of medical insurance, this allow the third party to determine that the provider is authentic, the patient is who they say they are, and that they are both present at the same place and time that services, treatment, prescriptions, durable medical equipment, or the like, is provided.

Thus, Medicare fraud and other insurance fraud can be significantly reduced by using the methods described herein. For example, for payment of a provider to occur, the system of the various embodiments requires verifying the patient and the provider, verifying that they are together in space and time, and exchanging valid MISTA information to prove the transaction. In such configurations, each party is provided authenticated transaction tokens 516 and is assured that the transaction cannot occur unless both trusted paths agree on the MISTA information.

As noted above, tokens may be ephemeral in that they are only provided with the appropriate coded authentication information once and for a short period of time. Many transaction schemes depend on codes provided locally, (e.g., a random number) and remotely, but each is based on the use of a common seed and a number selected based in a pre-defined fashion. Thus, if the seed and selection process are discovered, the authenticating information can be spoofed. In contrast, the token this transaction in accordance with the various embodiments can also carries the position, location, time and authenticated individual parameters to all participants in the transaction including the third party. Thus, it becomes harder to spoof. Further, the token need not be based on a common seed and/or random number generation process to avoid discovery of the underlying process.

Further, at any moment, either party may spontaneously re-initiate a verification operation, such as in response to changing conditions. For example, a doctor and patient have already identified each other and this identification may also include an authentication as to skills and identity. Thereafter, an examination discloses an entirely new disease or condition that may not be in the skill range of the provider, in the coverage range of the payer, or that is improbable for a given patient (e.g., Tay-Sachs disease in person other than those of Eastern European Ashkenazi Jewish descent). Thus, upon entering such information to the payer, the payer may require one or both parties to re-initiate the verification to allow the information to be processed or to at least pass on the patient information regarding the provider's skill range for the new diagnosis or the level of coverage that will be provided. Alternatively, the verification can be triggered to prevent the provider from proceeding alone. That is, certain diagnoses may require the involvement of additional specialists, therapists, etc. Thus, the verification process may not be successful until such parties are involved. Alternatively, the verification process may limit certain actions (i.e., certain treatments) to only certain types of providers.

In another example, when two parties working on a classified or restricted project meet they can authenticate each other to ensure that the proper parties are speaking. At some point, a higher level of clearance for one of the parties may be required to continue the meeting past a certain point. The clearances may already exist or may be created on the fly as required to not impede progress by a third party classifying authority. However, prior to divulging any classified or restricted information (i.e., to ensure the proper clearances are in place), the parties can re-initiate the verification. (In some cases, access can be controlled by requiring such verification via the third party classifying authority.) This access can be for a limited time. Thus, once the clearance is removed, the parties can again re-initiate the verification to ensure removal. A similar approach can be utilized when the parties move about a secure facility.

As noted above, the methods described herein are not limited to solely the identification of individuals. Rather, the methods described herein can also be used for authentication of objects and entities.

Another utility is to provide the identification of specific contents and characteristics of objects, individuals and entities. Such configuration can assist in the selection of appropriate goods and services when a transaction is to occur. For example, in the case of a purchasing car parts or car repairs, such as purchasing new tires, an authentication process as described above can allow the buyer and seller of the tire are assured that it is the correct tire (size, load and speed rating), are being sold by an authorized dealer for the tire, to store and the time and place when it was installed, and that the service was authorized by a valid driver or owner of the vehicle. Further, the tire manufacturer can be assured, as a third party, that the tire was installed by an authorized dealer and what the warranty parameters were maintained.

In another example, two vehicles, meeting to exchange passengers, cargo, or the like, can use the methods described herein to identify each other and ensure that a proper exchange is performed. That is, the individuals associated with the vehicles can confirm the identity of each other, but also confirm the transfer to occur.

An additional advantage, with respect to vehicle is that fixed routing of such vehicles is no longer required. For example, the conventional means of ensuring that vehicles associated with an exchange of passengers or cargo are authorized for such an exchange is to have such vehicles meet at a central facility or terminal. However, in many cases, such a terminal or central facility cannot be located at the most ideal location for purposes of fuel efficiency, passenger routing, or cargo pickup and drop-off. By providing the means of secure identification described herein, it is possible to securely authenticate vehicle, passengers, and cargo at any location, eliminating or at least reducing the need to utilize central facilities or terminals. That is, such vehicles could be routed to alternate locations and authorization of the transfer can be conducted via the secure identification described herein using, for example, handheld computing devices of the drivers or other persons associated with the vehicles.

In still another example, a retail store can use the methods described here to reduce or eliminate the requirement for checkout kiosks and clerk personnel, as well as save on security and re-stocking costs. In such a configuration, customers may select desired items, read the item's UPC codes with their intelligent device and allocate sufficient credits in the device. When exiting the store, the customer can display a machine readable code with information regarding the proposed purchase to a security guard. An exchange, as described above, can then occur to complete the transaction and to confirm to the security guard that the transaction was valid and that the appropriate funds have been transferred to the store's account. For example, a third party, e.g., bank, would then transfer the payment, authorized through the buyer's trusted path, to the store's accounts receivable.

Still another example is the use of the identification features when a patient visits a doctor or is delivered a prescription. As before, the intelligent devices are positioned to identify each participant to the other, make monetary or information transfers, as well as establish the location and time of the meeting. As such, for example, a Medicare or other healthcare transaction might be authorized and recorded linking the care provider with the patient at a common place and time. As stated earlier, this would be especially useful in establishing the basis for fraud detection such that care could not be provided, except as authorized. The care provider and their credentials are authenticated by any or all of the servers involved, the patient records are thereby associated only with the true identity of the patient. Situations where one patient impersonates another would be thwarted, where a provider might bill for services not rendered or rendered to a fictitious or unauthorized individual or rendered at a common location where the provider and patient are both resident at the same time.

Further, in the case of a prescription, a prescription is associated with the doctor and delivered to a pharmacist. The individual picking up the prescription must be the same (or authorized surrogate care giver) and the delivery location and time are recorded and provided to the insurance company or other payer. In the case of controlled substances, this would thwart the use of a prescription obtained by one person to be sold to another for the purpose of substance abuse.

Similarly, in the field of security supplies, military supply distribution, or distribution of other dangerous or restricted devices and substances, the above means could be used for the controlled sale. Especially for controlled sales of firearms, explosives, materials to create explosives, poisons and other restricted items. In such configurations, the third party receiving the authenticated acknowledgement or the trusted party of the transaction can be associated with a government agency. Thus, when such transfers between individuals occur, then they can be tracked and traced by this means without much delay or administrative burden on the individuals.

Still, another application might be for the secure authorization of personal identity of two individuals in other scenario, perhaps with only a nominal transfer of credit so as to use the secure credit transaction means for establishing identity. For example, a person who is answering a classified ad, a couple meeting for the first time in an internet dating scenario, or an individual looking for other members of a group in a crowd. Similarly, an application might be to identify strangers, such as a limo driver picking up a group or individuals in a social network identifying other members of the group at the onset of an activity. Even a police officer in a traffic stop or other personal encounter might identify himself to a citizen, with the citizen assured of the authenticity of the police officer and the police assured of the identity of the citizen. Further, the meeting (i.e., the transaction) can be recorded for evidence of the encounter to a governmental third party.

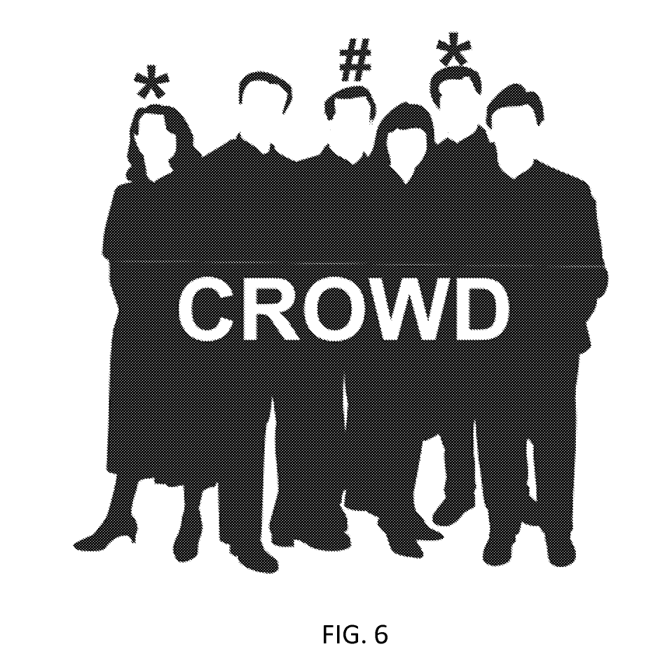

In some configurations, handheld devices can use a beacon to broadcast information, as described above, to emit serial information as a stream of encrypted data. This data can be sensed by a receiving intelligent handheld device to provide the augmented reality. That is, in the scene from a camera, labels and captions can be added into the viewing screen for transient objects or individuals, as illustrated in FIG. 6. This secure augmented reality group handshake is typically only visible to members of the group who share the encryption codes.

Another use of the beacon capabilities is in some types of retail transactions. These could be authorized via a payment provided using a machine readable code generated via beacon in close proximity or at a distance. For example, one might order a meal by its barcode, transfer the payment information encrypted (potentially generated via a one-time unique key) to a receiver device across the room, and receive the meal without surrendering the credit identification (credit card) to a stranger.

Another use of the various embodiments is to provide the ability for emergency personnel to identify one another or to identify victims by optical serial information beamed from handheld devices. One could imagine even unconscious individuals could be detected, authenticated by their proxy identification devices (e.g., triggered by hi G forces or atmospheric pressure impulses). This could be valuable in accidents, crimes, natural disasters, fires and the like, where the scope of the incident would have required intelligent coordination and communication between emergency, medical, and recovery skills that is beyond human abilities. Similarly, this concept can have utility on the battlefield.

The applications to Homeland Security, or law enforcement, for the identification of individuals, singly or within a group are useful. In this scenario, the supervising servers might contain identity information such that a group of known individuals could be distinguished from unknown individuals. The known individuals would have authorized encryption codes, perhaps related to passport data acquired through the supervisory servers and those individuals without this data would be unknown. This might even speed the passport or transportation security process, even to individuals moving in vehicles. Access to secure areas could be similarly automated, and friend or foe identification on a battlefield between humans or robotic devices might be established as well.

The key element here is the unique displayable, near-field transmittable, code that is ephemerally produced by a central source on demand, then received, then authenticated and returned to the central source as acknowledgement and forwarded to a third party as verification.

It should be noted that an embedded or implanted ID chip can work in concert with a connected mobile device to produce equivalent function and results, with the advantage of more positive identification.

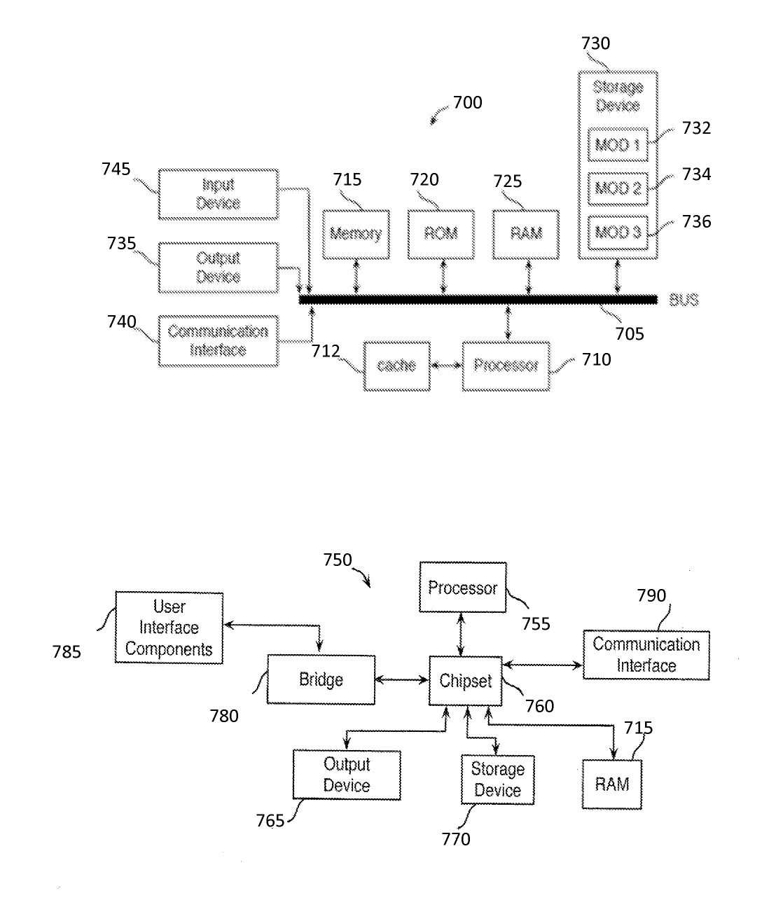

FIG. 7A and FIG. 7B illustrate exemplary possible configurations for a computing device for implementing the various embodiments. The more appropriate embodiment will be apparent to those of ordinary skill in the art when practicing the present technology. Persons of ordinary skill in the art will also readily appreciate that other system embodiments are possible.

FIG. 7A illustrates a conventional system bus computing system architecture 700 wherein the components of the system are in electrical communication with each other using a bus 705. Exemplary system 700 includes a processing unit (CPU or processor) 710 and a system bus 705 that couples various system components including the system memory 715, such as read only memory (ROM) 720 and random access memory (RAM) 725, to the processor 710. The system 700 can include a cache of high-speed memory connected directly with, in close proximity to, or integrated as part of the processor 710. The system 700 can copy data from the memory 715 and/or the storage device 730 to the cache 712 for quick access by the processor 710. In this way, the cache can provide a performance boost that avoids processor 710 delays while waiting for data. These and other modules can control or be configured to control the processor 710 to perform various actions. Other system memory 715 may be available for use as well. The memory 715 can include multiple different types of memory with different performance characteristics. The processor 710 can include any general purpose processor and a hardware module or software module, such as module 1 732, module 2 734, and module 3 736 stored in storage device 730, configured to control the processor 710 as well as a special-purpose processor where software instructions are incorporated into the actual processor design. The processor 710 may essentially be a completely self-contained computing system, containing multiple cores or processors, a bus, memory controller, cache, etc. A multi-core processor may be symmetric or asymmetric.

To enable user interaction with the computing device 700, an input device 745 can represent any number of input mechanisms, such as a microphone for speech, a touch-sensitive screen for gesture or graphical input, keyboard, mouse, motion input, speech and so forth. An output device 735 can also be one or more of a number of output mechanisms known to those of skill in the art. In some instances, multimodal systems can enable a user to provide multiple types of input to communicate with the computing device 700. The communications interface 740 can generally govern and manage the user input and system output. There is no restriction on operating on any particular hardware arrangement and therefore the basic features here may easily be substituted for improved hardware or firmware arrangements as they are developed.

Storage device 730 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 725, read only memory (ROM) 720, and hybrids thereof.

The storage device 730 can include software modules 732, 734, 736 for controlling the processor 710. Other hardware or software modules are contemplated. The storage device 730 can be connected to the system bus 705. In one aspect, a hardware module that performs a particular function can include the software component stored in a computer-readable medium in connection with the necessary hardware components, such as the processor 710, bus 705, display 735, and so forth, to carry out the function.

FIG. 7B illustrates a computer system 750 having a chipset architecture that can be used in executing the described method and generating and displaying a graphical user interface (GUI). Computer system 750 is an example of computer hardware, software, and firmware that can be used to implement the disclosed technology. System 750 can include a processor 755, representative of any number of physically and/or logically distinct resources capable of executing software, firmware, and hardware configured to perform identified computations. Processor 755 can communicate with a chipset 760 that can control input to and output from processor 755. In this example, chipset 760 outputs information to output 765, such as a display, and can read and write information to storage device 770, which can include magnetic media, and solid state media, for example. Chipset 760 can also read data from and write data to RAM 775. A bridge 780 for interfacing with a variety of user interface components 785 can be provided for interfacing with chipset 760. Such user interface components 785 can include a keyboard, a microphone, touch detection and processing circuitry, a pointing device, such as a mouse, and so on. In general, inputs to system 750 can come from any of a variety of sources, machine generated and/or human generated.

Chipset 760 can also interface with one or more communication interfaces 790 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 755 analyzing data stored in storage 770 or 775. Further, the machine can receive inputs from a user via user interface components 785 and execute appropriate functions, such as browsing functions by interpreting these inputs using processor 755.

It can be appreciated that exemplary systems 700 and 750 can have more than one processor 710 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

While various embodiments of the present invention have been described above, it should be understood that they have been presented by way of example only, and not limitation. Numerous changes to the disclosed embodiments can be made in accordance with the disclosure herein without departing from the spirit or scope of the invention. Thus, the breadth and scope of the present invention should not be limited by any of the above described embodiments. Rather, the scope of the invention should be defined in accordance with the following claims and their equivalents.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

The terminology used herein is for the purpose of describing particular embodiments only and is not intended to be limiting of the invention. As used herein, the singular forms “a”, “an” and “the” are intended to include the plural forms as well, unless the context clearly indicates otherwise. Furthermore, to the extent that the terms “including”, “includes”, “having”, “has”, “with”, or variants thereof are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

What is claimed is:

1. A method of secure authentication, comprising
providing, from a first server to a first client associated with a first party to a transaction, an authorization to generate machine readable code representing one or more items available for transfer and identity information of a first party;
receiving, at a second server from a second client associated with a second party to a transaction, a request based on an interpretation of the machine readable pattern, the request comprising an identity associated with the machine readable code and a request for transfer of at least a portion of the items specified in the machine readable code;
forwarding, from the second server to the first server, a communication for the first server to process the request;
responsive to completion of the processing of the request, transferring the items between the first server and the second server and configuring the first server to notify the first client of the transfer of the items and configuring the second server to notify the second client of the transferring of the items.

2. The method of claim 1, wherein responsive to a failure to complete the processing of the request, configuring the first server to notify the first client of the failure, and configuring the second server to notify the second client of the failure.

3. The method of claim 1, wherein the items comprise financial information.

4. The method of claim 1, wherein the items comprise additional identification information.

5. The method of claim 1, further comprising:
providing a first supervisory server associated with the first server;
providing a second supervisory server associated with the second server; and
configuring the first supervisory server and the second supervisory server to complete a handshake operation prior to the processing of the request.

6. The method of claim 1, further comprising applying an encryption process to transmit and receive messages between the first server and the first device and between the second server and the second device.

7. The system of claim 7, wherein an encryption key for the encryption process is selected to be valid for only a limited time.

8. A client device for secure authentication processes, comprising
a processor; and
a computer-readable medium, having stored thereon a plurality of instructions for causing the processor to perform a method comprising:
receiving, from a first server, an authorization to generate machine readable code representing one or more items available for transfer and identity information of a first party to a transaction;
providing, to a other client device associated with a second party to a transaction, the machine readable pattern;
subsequent to the providing, receiving, from the first server, an indication of the completion of the processing of a request from the other client device to the second server to authenticate the transaction via an authentication process between the first server and a second server and that items were are transferred between the first server and the second server.

9. The system of claim 8, further comprising, subsequent to the providing, receiving, from the first server, an indication of a failure to complete of the processing of a request from the other client device to the second server to authenticate the transaction via an authentication process between the first server and a second server.

10. The system of claim 8, wherein the items comprise financial information.

11. The system of claim 8, wherein the items comprise additional identification information.

12. The system of claim 8, further the plurality of instructions further comprising instructions for causing the processor to perform the receiving of the authorization and the receiving of the indication using encrypted communications via a secure terminal.

13. The system of claim 8, wherein an encryption key for the encrypted communications is valid for only a limited time.

14. A client device for secure authentication processes, comprising
a processor; and
a computer-readable medium, having stored thereon a plurality of instructions for causing the processor to perform a method comprising:
receiving, from a other client device associated with a first party to a transaction, a machine readable pattern representing one or more items available for transfer and identity information of the first party;
transmitting a message to a second server, the message based on an interpretation of the machine readable pattern, and the message comprising the identity associated with the machine readable code and a request for transfer of at least a portion of the items specified in the machine readable code from a first server associated with the first party to the second server;
subsequent to the transmitting, receiving, from the second server, an indication of a completion of the processing of the identity and the request via an authentication process between the first server and a second server and that items were are transferred between the first server and the second server.

15. The system of claim 14, further comprising, subsequent to the transmitting, receiving, from the second server, an indication of a failure to complete of the processing of the identity and the request via the authentication process.

16. The system of claim 14, wherein the items comprise financial information.

17. The system of claim 14, wherein the items comprise additional identification information.

18. The system of claim 14, further the plurality of instructions further comprising instructions for causing the processor to perform the transmitting and the receiving of the indication using encrypted communications via a secure terminal.

19. The system of claim 18, wherein an encryption key for the encrypted communications is valid for only a limited time.
